(19) United States
(12) Patent Application Publication
(10) Pub. No.: US 2016/0044865 A1
(43) Pub. Date: Feb. 18, 2016

(54) Rotating Trimmer Head Device

(71) Applicant: Martin Hermann, Mona Vale NSW 1660 (AU)

(72) Inventor: Martin Hermann, Mona Vale NSW 1660 (AU)

(21) Appl. No.: 14/457,276

(22) Filed: Aug. 12, 2014

(51) Int. Cl. A01D 34/416

(52) U.S. Cl. CPC A01D 34/4166; A01D 34/4168

(57) ABSTRACT

A rotating trimmer head device provides durable non-wound trimmer line extending from swiveling connectors coupled to a trimmer head. The device includes a trimmer head having a top section and a bottom section. A top surface of the bottom section is structured to have a plurality of bottom sockets and a bottom surface of the top section is structured to have a plurality of top sockets. Each of the bottom sockets is linearly aligned with an associated one of the top sockets to define a respective line receiver in the trimmer head. Each of a plurality of line connectors is positioned in an associated one of the line receivers. Each of a plurality of trimmer lines is coupled to and extends from an associated one of the line connectors such that the trimmer line extends from the trimmer head.

### BACKGROUND OF THE DISCLOSURE

### Field of the Disclosure

The disclosure relates to trimmer head devices and more particularly pertains to a new trimmer head device for providing durable non-wound trimmer line extending from swiveling connectors coupled to a trimmer head.

### SUMMARY OF THE DISCLOSURE

An embodiment of the disclosure meets the needs presented above by generally comprising a trimmer head having a top section and a bottom section. A top surface of the bottom section is structured to have a plurality of bottom sockets and a bottom surface of the top section is structured to have a plurality of top sockets. Each of the bottom sockets is linearly aligned with an associated one of the top sockets to define a respective line receiver in the trimmer head. Each of a plurality of line connectors is positioned in an associated one of the line receivers. Each of a plurality of trimmer lines is coupled to and extends from an associated one of the line connectors such that the trimmer line extends from the trimmer head.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a bottom front side perspective view of a rotating trimmer head device according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure taken along line 4-4 of FIG. 2.

FIG. 5 is a top view of a line connector of an embodiment of the disclosure.

### DESCRIPTION OF THE PREFERRED EMBODIMENT

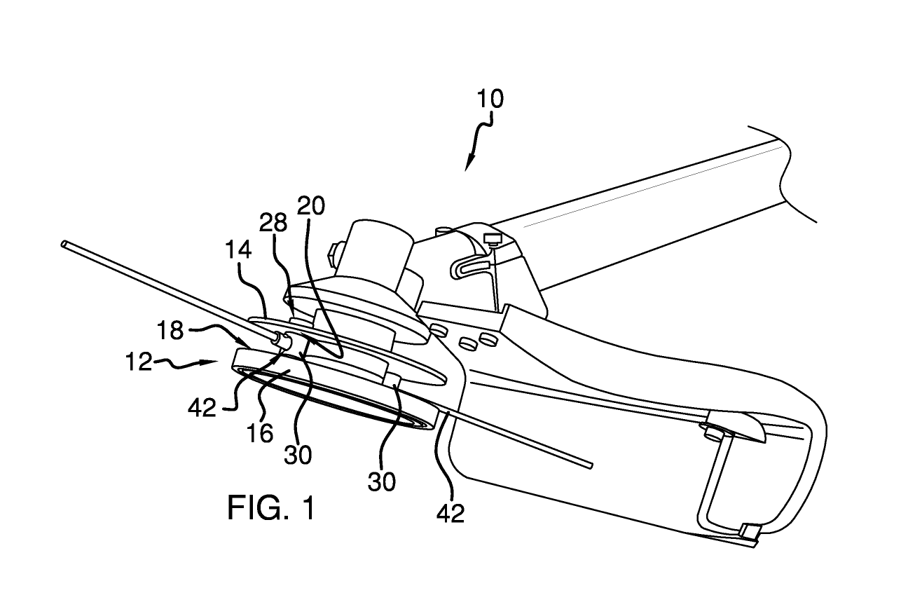

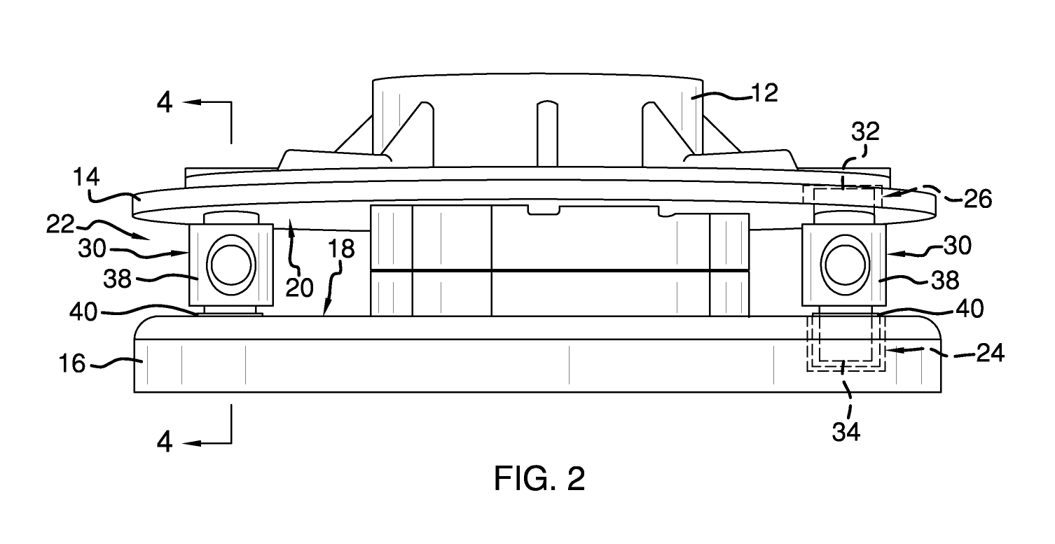

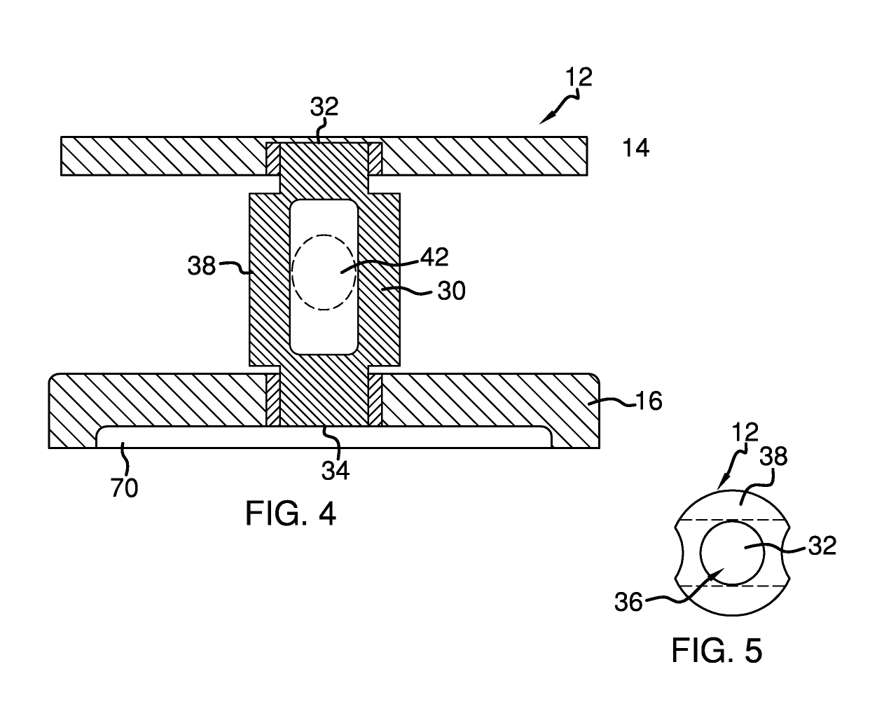

With reference now to the drawings, and in particular to FIGS. 1 through 5 thereof, a new trimmer head device embodying the principles and concepts of an embodiment of the disclosure and generally designated by the reference numeral 10 will be described.

As best illustrated in FIGS. 1 through 5, the rotating trimmer head device 10 generally comprises a trimmer head 12 configured for coupling to a conventional weed trimmer in a conventional manner such that the weed trimmer rotates the trimmer head 12. The trimmer head 12 has a top section 14 and a bottom section 16. The trimmer head 12 is constructed substantially of a light weight durable plastic material of the type conventionally used in existing trimmer devices. A top surface 18 of the bottom section 16 is positioned in spaced relationship to a bottom surface 20 of the top section 14 defining a circumferential groove 22 extending around the trimmer head 12. The top surface 18 of the bottom section 16 is structured to have a plurality of bottom sockets 24. The bottom surface 20 of the top section 14 is structured to have a plurality of top sockets 26. Each of the bottom sockets 24 is linearly aligned with an associated one of the top sockets 26 to define a respective line receiver 28 in the trimmer head 12 when the top section 14 is securely coupled to the bottom section 16. The top section 14 may be removably coupled to the bottom section 16 in a conventional manner. The top surface 18 of the bottom section 16 is parallel to the bottom surface 20 of the top section 14. The line receivers 28 may be two total. Multiple pairs of the line receivers 28 may be incorporated into the trimmer head 12 as described with the line receivers 28 being radially arranged into linearly aligned pairs and evenly spaced to maintain balance of the trimmer head 12 during rotation.

Each of a plurality of line connectors 30 has a first end 32 and a second end 34. The first end 32 of each line connector 30 is positioned in an associated one of the top sockets 26 while the second end 34 of each line connector 30 is positioned in an associated one of the bottom sockets 24. Thus, each line connector 30 is coupled to an associated one of the line receivers 28. The first end 32 and second end 34 of each line connector 30 is defined by a cylindrical disc shape 36 such that the first end 32 is cylindrical and the second end 34 is also cylindrical. Thus, the first end 32 and the second end 34 of each line connector 30 are each rotatable within the line receiver 28. Each line connector 30 has a medial section 38 positioned between the first end 32 and the second end 34. The medial section 38 is cylindrical and coaxial with the first end 32 and the second end 34. An outer diameter of the first end 32 is equal to an outer diameter of the second end 34. An outer diameter of the medial section 38 may be greater than the outer diameter of the first end 32 and thus, the second end 34 as well. Each line connector 30 may be constructed of a metal material, alloy, or the like to be substantially more durable than the hard plastics conventionally used in trimmer devices currently. Each of a plurality of bushings 40 is positioned in and lines an associated one of the top sockets 26 and the bottom sockets 24. Each of the bushings 40 is constructed of a metal material, alloy or the like to be similarly more durable than conventional plastics.

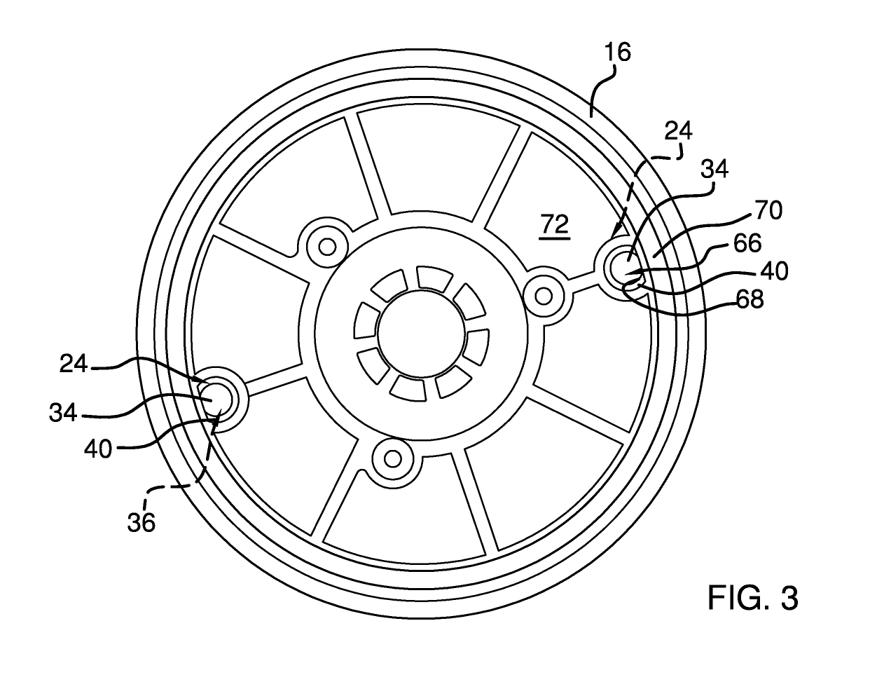

Each of the bottom sockets 24 may have a partially exposed base end 66 as shown in FIG. 3. A shelf 68 may be formed in each bottom socket 24 by an annular wall 70 extending from a bottom surface 72 of the bottom section 16 of the trimmer head 12.

Each of a plurality of trimmer lines 42 is coupled to and extends from an associated one of the line connectors 30 such that the trimmer line 42 extends from the trimmer head 12. The trimmer line 42 pivots or swivels relative to the trimmer head 12 as the line connector 30 moves within the associated line receiver 28. The trimmer lines 42 may be constructed of a conventional plastic line material for durability and desired weight for cutting material when the trimmer head 12 is rotated. Each trimmer line 42 may be coupled to the line connector 30 in a removable and replaceable manner.

In use, the trimmer head 12 is installed on a trimmer device in a conventional manner. The line connectors 30 are positioned in and retained on the trimmer head 12 by the line receivers 28. The trimmer lines 42 are coupled to the line connectors 30 such that the trimmer lines 42 extend from the trimmer head 12 and cut vegetation or other material as the trimmer head 12 is rotated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rotating trimmer head device comprising:
a trimmer head having a top section and a bottom section;
a top surface of said bottom section being positioned in spaced relationship to a bottom surface of said top section defining a circumferential groove extending around said trimmer head, said top surface of said bottom section being structured to have a plurality of bottom sockets, said bottom surface of said top section being structured to have a plurality of top sockets, each of said bottom sockets being linearly aligned with an associated one of said top sockets to define a respective line receiver in said trimmer head;
a plurality of line connectors, each of said line connectors having a first end and a second end, said first end of each said line connector being positioned in an associated one of said top sockets, said second end of each said line connector being positioned in an associated one of said bottom sockets wherein each said line connector is coupled to an associated one of said line receivers; and
a plurality of trimmer lines, each trimmer line being coupled to and extending from an associated one of said line connectors such that said trimmer line extends from said trimmer head.

2. The device of claim 1, further comprising said first end of each said line connector being cylindrical and said second end of each said line connector being cylindrical wherein each said line connector is rotatable within said line receiver.

3. The device of claim 1, further comprising said top surface of said bottom section being parallel to said bottom surface of said top section.

4. The device of claim 1, further comprising each said line connector being constructed of a metal material.

5. The device of claim 1, further comprising each said line connector having a medial section positioned between said first end and said second end, said medial section being cylindrical and coaxial with said first end and said second end.

6. The device of claim 5, further comprising an outer diameter of said first end being equal to an outer diameter of said second end.

7. The device of claim 6, further comprising an outer diameter of said medial section being greater than said outer diameter of said first end.

8. The device of claim 1, further comprising a plurality of bushings, each of said bushings being positioned in and lining an associated one of said top sockets and said bottom sockets.

9. The device of claim 8, further comprising each of said bushing being constructed of a metal material.

10. The device of claim 1, further comprising said trimmer head being constructed of a plastic material.

11. A rotating trimmer head device comprising:
a trimmer head having a top section and a bottom section, said trimmer head being constructed of a plastic material;
a top surface of said bottom section being positioned in spaced relationship to a bottom surface of said top section defining a circumferential groove extending around said trimmer head, said top surface of said bottom section being structured to have a plurality of bottom sockets, said bottom surface of said top section being structured to have a plurality of top sockets, each of said bottom sockets being linearly aligned with an associated one of said top sockets to define a respective line receiver in said trimmer head, said top surface of said bottom section being parallel to said bottom surface of said top section;
a plurality of line connectors, each of said line connectors having a first end and a second end, said first end of each said line connector being positioned in an associated one of said top sockets, said second end of each said line connector being positioned in an associated one of said bottom sockets wherein each said line connector is coupled to an associated one of said line receivers, said first end of each said line connector being cylindrical and said second end of each said line connector being cylindrical wherein each said line connector is rotatable within said line receiver, each said line connector having a medial section positioned between said first end and said second end, said medial section being cylindrical and coaxial with said first end and said second end, an outer diameter of said first end being equal to an outer diameter of said second end, an outer diameter of said medial section being greater than said outer diameter of said first end, each said line connector being constructed of a metal material;
a plurality of bushings, each of said bushings being positioned in and lining an associated one of said top sockets and said bottom sockets, each of said bushing being constructed of a metal material; and
a plurality of trimmer lines, each trimmer line being coupled to and extending from an associated one of said line connectors such that said trimmer line extends from said trimmer head.
